(19) United States
(12) Patent Application Publication
(10) Pub. No.: US 2015/0040003 A1
(43) Pub. Date: Feb. 5, 2015

(54) Non-Transitory Computer-Readable Medium, Communication Device, and Communication Method

(71) Applicant: Brother Kogyo Kabushiki Kaisha, Nagoya-shi (JP)

(72) Inventors: Dzulkhiflee Bin Hamzah Muhammed, Nagoya-shi (JP); Yoshiyuki Kondo, Okazaki-shi (JP)

(73) Assignee: BROTHER KOGYO KABUSHIKI KAISHA, Nagoya-shi (JP)

(21) Appl. No.: 14/446,979

(22) Filed: Jul. 30, 2014

(30) Foreign Application Priority Data
Jul. 31, 2013 (JP) 2013-159840

(51) Int. Cl. G06F 17/21; H04L 29/06

(52) U.S. Cl. CPC G06F 17/212; H04L 65/403; G06F 17/217
USPC 715/246

(57) ABSTRACT

A first receiving operation receives specific position information from a first communication. A first determination operation determines whether block position information corresponding to the specific position indicated by the received specific position information is included in first block information stored in a storage device. A setting operation sets a magnification factor of a target block image in response to a case in which it is determined that the block position information corresponding to the specific position is included in the first block information. A processing operation processes the target block image based on the set magnification factor. A display operation displays the processed target block image on the display.

### CROSS-REFERENCE TO RELATED APPLICATION

This application claims priority to Japanese Patent Application No. 2013-159840 filed on Jul. 31, 2013, the disclosure of which is herein incorporated by reference in its entirety.

### BACKGROUND

The present disclosure relates to a non-transitory computer-readable medium, a communication device, and a communication method for supporting a conference, etc., which is implemented between a presenter's terminal device and a participant's terminal device, by causing a presentation document, to which the presenter refers at the time of a presentation, to be displayed on a communication device used by the participant.

A system has been proposed that is capable of displaying a document, to which a presenter refers at the time of a presentation, on a communication device used by a participant. For example, a mobile terminal conference system is known that is provided with a server, a presenter's terminal, and a participant's terminal. The presenter's terminal transmits an image file of document to the server before a conference is started. After the conference is started, the presenter's terminal transmits, to the server, information that indicates a position of a mouse pointer. The participant's terminal receives, from the server, information that indicates the image file and the position of the mouse pointer. Based on the image file, the participant's terminal displays the document on a display device. The participant's terminal can enlarge the document while using the position of the mouse pointer as a reference.

### SUMMARY

Depending on a magnification factor by which the participant's terminal enlarges a document, the document may not fit inside a display area of the display device in some cases. In those cases, as the participant cannot observe a part of the document that is not displayed in the display area, there is a possibility that the participant cannot recognize a content of the document.

Various embodiments of the general principles herein provide a non-transitory computer-readable medium, a communication device, and a communication method that enable a user of a communication device to easily recognize a content of a document.

The embodiments described herein provide a non-transitory computer-readable medium storing computer-readable instructions. The instructions, when executed by a processor of a communication device, perform processes that include a first receiving operation, a first determination operation, a setting operation, a processing operation, and a display operation. The first receiving operation receives, from an another communication device via a network, specific position information indicating a specific position in a display area on a display of the communication device. The first determination operation determines whether block position information corresponding to the specific position indicated by the received specific position information is included in first block information stored in a storage device. The block position information indicates a position at which one of a plurality of block images is arranged. The plurality of block images is included in a display image of one page displayed on the display. The first block information is information in which a plurality of pieces of page information are associated with a plurality of pieces of block position information. Each of the plurality of pieces of page information respectively identifies each of a plurality of display images corresponding to a plurality of pages. Each of the plurality of pieces of block position information indicates positions of the plurality of block images included in each of the display images for the plurality of the pages. The setting operation sets a magnification factor of a target block image in response to determining that the block position information corresponding to the specific position is included in the first block information. The target block image is a block image among the plurality of block images. The target block image is arranged at a position indicated by the block position information corresponding to the specific position. The magnification factor is one of a first factor and a second factor. The first factor corresponds to a ratio of a length of the display area in the first direction to a length of the target block image in a first direction. The second factor corresponds to a ratio of a length of the display area in the second direction to a length of the target block image in a second direction. The second direction is a direction perpendicular to the first direction. The processing operation processes the target block image based on the set magnification factor. The display operation displays the processed target block image on the display.

The embodiments described herein also provide a communication device that includes a processor and a memory storing computer-readable instructions. The instructions, when executed by a processor of a communication device, perform processes that include a first receiving operation, a first determination operation, a setting operation, a processing operation, and a display operation. The first receiving operation receives, from an another communication device via a network, specific position information indicating a specific position in a display area on a display of the communication device. The first determination operation determines whether block position information corresponding to the specific position indicated by the received specific position information is included in first block information stored in a storage device. The block position information indicates a position at which one of a plurality of block images is arranged. The plurality of block images is included in a display image of one page displayed on the display. The first block information is information in which a plurality of pieces of page information are associated with a plurality of pieces of block position information. Each of the plurality of pieces of page information respectively identifies a plurality of display images corresponding to a plurality of pages. Each of the plurality of pieces of block position information indicates positions of the plurality of block images included in each of the display images for the plurality of the pages. The setting operation sets a magnification factor of a target block image in response to determining that the block position information corresponding to the specific position is included in the first block information. The target block image is a block image among the plurality of block images. The target block image is arranged at a position indicated by the block position information corresponding to the specific position. The magnification factor is one of a first factor and a second factor. The first factor corresponds to a ratio of a length of the display area in the first direction to a length of the target block image in a first direction. The second factor corresponds to a ratio of a length of the display area in the second direction to a length of the target block image in a second direction. The second direction is a direction perpendicular to the first direction. The processing operation processes the target block image based on the set magnification factor. The display operation displays the processed target block image on the display.

The embodiments described herein further provide a communication method that includes a receiving operation, an identification operation, a magnification operation, and a display operation. The receiving operation receives, from an another communication device via a network, specific position information indicating a specific position in a display area on a display of a communication device. The identification operation identifies block position information corresponding to the specific position indicated by the received specific position information. The block position information indicates a position at which one of a plurality of block images is arranged. The plurality of block images is included in a display image of one page that is displayed on the display. The magnification operation magnifies a target block image. The target block image is a block image among the plurality of block images arranged at a position indicated by the block position information corresponding to the specific position. The display operation displays the magnified target block image on the display.

### BRIEF DESCRIPTION OF THE DRAWINGS

Embodiments of the present disclosure will be described below in detail with reference to the accompanying drawings in which:

FIG. 1 is a diagram showing an overview of a remote conference system.

FIG. 2 is a diagram showing a display screen.

FIG. 3 is a diagram showing a communication sequence.

FIG. 4 is a flowchart of analysis processing.

FIG. 5 is an explanatory diagram illustrating an analysis method.

FIG. 6 is a schematic diagram of a block table.

FIG. 7 is an explanatory diagram illustrating a detection method of a specific operation.

FIG. 8 is a flowchart of detection processing.

FIG. 9 is an explanatory diagram illustrating the detection method of the specific operation.

FIG. 10 is a schematic diagram showing a packet.

FIG. 11 is a flowchart of transmission processing.

FIG. 12 is a flowchart of display processing.

FIG. 13 is a diagram showing the display screen.

FIG. 14 is a diagram showing the display screen.

FIG. 15 is a diagram showing the display screen.

### DETAILED DESCRIPTION

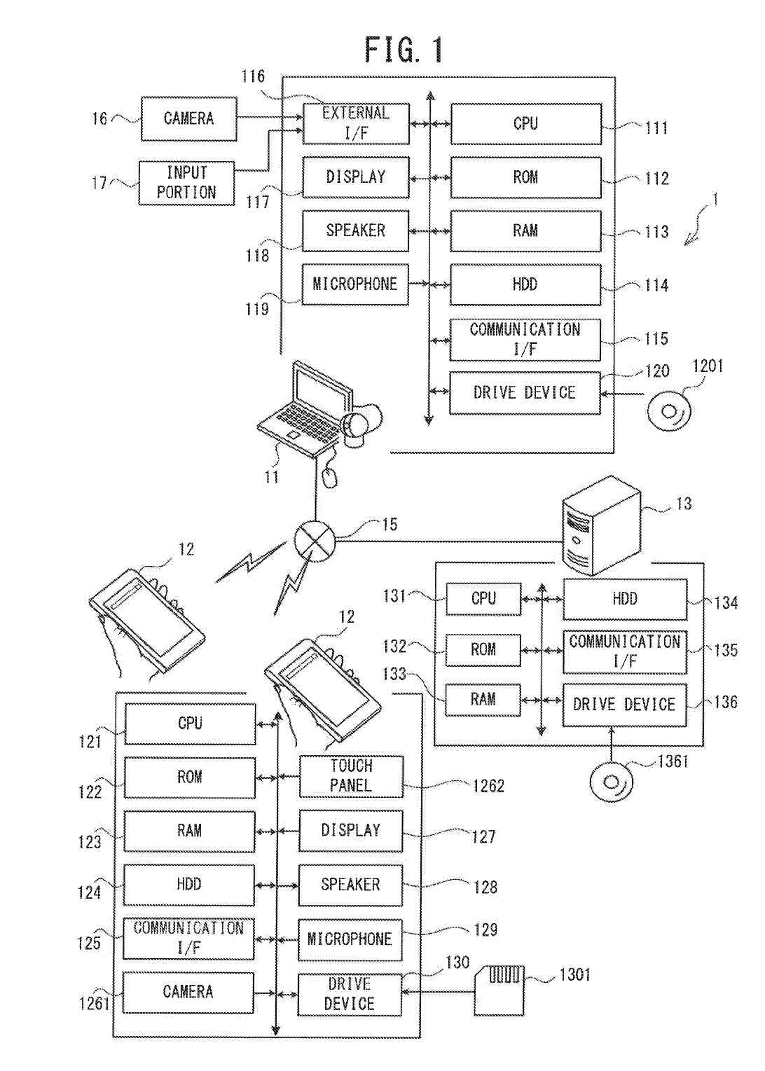

A remote conference system 1 will be described with reference to FIG. 1. The remote conference system 1 includes a first terminal 11, a second terminal 12, and a server 13. The first terminal 11, the second terminal 12, and the server 13 are communicably connected with one another via a network 15. The remote conference system 1 supports implementation of a teleconference that is performed via a network. One example of the teleconference is a conference in which a presenter makes a presentation to a participant. For example, the first terminal 11 is a terminal device used by the presenter. The second terminal 12 is a terminal device used by the participant. The presenter proceeds with the conference in a presentation format while referring to a document image that is displayed on a display 117 of the first terminal 11 one page at a time. The participant views and listens to the presentation made by the presenter while referring to the document image that is displayed on a display 127 of the second terminal 12. The first terminal 11 is a known general-purpose personal computer (PC). The second terminal 12 is a known smartphone. The server 13 is a known multi-point control unit (MCU).

Note that at least one of the first terminal 11 and the second terminal 12 may be a special-purpose terminal for teleconferencing or may be a general-purpose PC, a smartphone, a special-purpose terminal, or a tablet PC. The first terminal 11 and the second terminal 12 may be devices of the same type. The server 13 may be a general-purpose server.

The second terminal 12 operates in one of two operation modes (a first mode and a second mode). The participant can set the operation mode of the second terminal 12 to either the first mode or the second mode. When the second terminal 12 operates in the first mode, the same one page of the document image that is displayed on the display 117 of the first terminal 11 is also displayed on the display 127 of the second terminal 12. When the page of the document image displayed on the display 117 of the first terminal 11 is updated, the page of the document image displayed on the display 127 of the second terminal 12 is updated in synchronization with the page update of the first terminal 11. The presenter and the participant recognize the same page of the document image via the first terminal 11 and the second terminal 12 respectively. The presenter can implement the conference in the presentation format while causing the participant to recognize a desired document image.

On the other hand, when the second terminal 12 operates in the second mode, unlike the case in which the second terminal 12 operates in the first mode, the page of the document image displayed on the display 127 of the second terminal 12 is not synchronized with the page of the document image displayed on the display 117 of the first terminal 11. The second terminal 12 displays on the display 127 the document image of a page that is selected by the participant. The participant can recognize a desired document image even in the middle of the presentation made by the presenter.

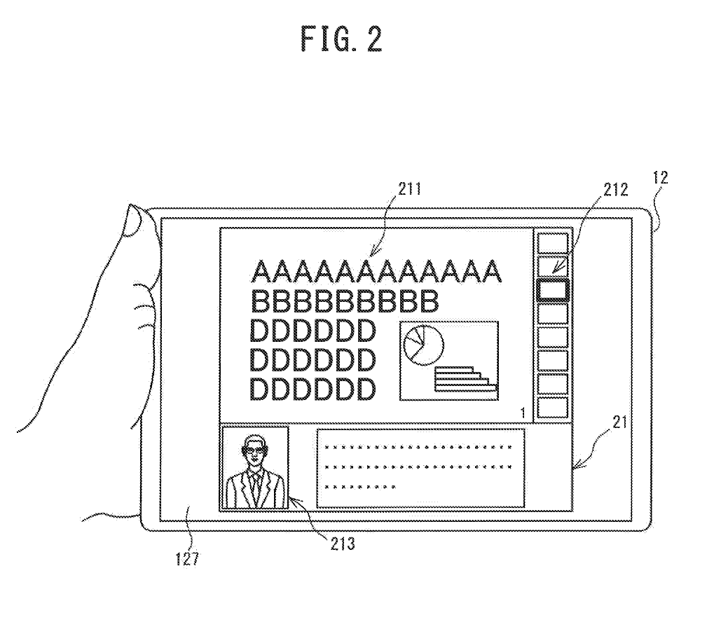

One example of a display screen (a display screen 21) that is displayed on the display 127 of the second terminal 12, will be described with reference to FIG. 2. Note that a display screen of the same layout is also displayed on the display 117 of the first terminal 11. The display screen 21 has a first area 211, a second area 212 and a third area 213. One page of the document image is displayed in the first area 211. Thumbnails of the document images for a plurality of pages are displayed in the second area 212. Among the thumbnails of the document images for the plurality of pages, the thumbnail corresponding to the document image displayed in the first area 211 is displayed with a bold line border. Video (video including the presenter, for example) that is captured by a camera 16 (refer to FIG. 1) of the first terminal 11 is displayed in the third area 213.

A case is described below as an example in which the presenter selects, via an input portion 17, one of the thumbnails for the plurality of the pages in the second area 212 of the display screen 21 displayed on the first terminal 11. The first terminal 11 displays the document image of the page corresponding to the selected thumbnail in the first area 211 of the display screen 21. When the second terminal 12 operates in the first mode, the second terminal 12 displays the document image of the page corresponding to the thumbnail selected by the presenter in the first area 211 of the display screen 21. Therefore, the document image of the same page is displayed in each of the first areas 211 of the display screen 21 on the first terminal 11 and on the second terminal 12.

On the other hand, when the second terminal 12 operates in the second mode, the second terminal 12 displays in the first area 211 of the display screen 21 the document image of a page corresponding to a thumbnail selected by the participant via a touch panel 1262 (refer to FIG. 1) among the thumbnails for the plurality of the pages in the second area 212. In this case, different document images may be displayed in each of the first areas 211 of the display screen 21 on the first terminal 11 and on the second terminal 12.

Further, in the present embodiment, when the presenter performs a predetermined operation via the input portion 17, the second terminal 12 processes at least a part of the document image such that the participant can clearly visually recognize a part of the document image on which the predetermined operation has been performed by the presenter. The second terminal 12 displays the document image, of which at least a part has been processed, in the first area 211 of the display screen 21. Details will be described below.

An electrical structure of the first terminal 11 will be described with reference to FIG. 1. The first terminal 11 includes a central processing unit (CPU) 111 that controls the first terminal 11. The CPU 111 is electrically connected to a read only memory (ROM) 112, a random access memory (RAM) 113, a hard disk drive (HDD) 114, a communication interface (I/F) 116, an external I/F 116, the display 117, a speaker 118, a microphone 119, and a drive device 120. A boot program and a basic input/output system (BIOS), etc. are stored in the ROM 112. Temporary data of a timer and a counter, etc. are stored in the RAM 113.

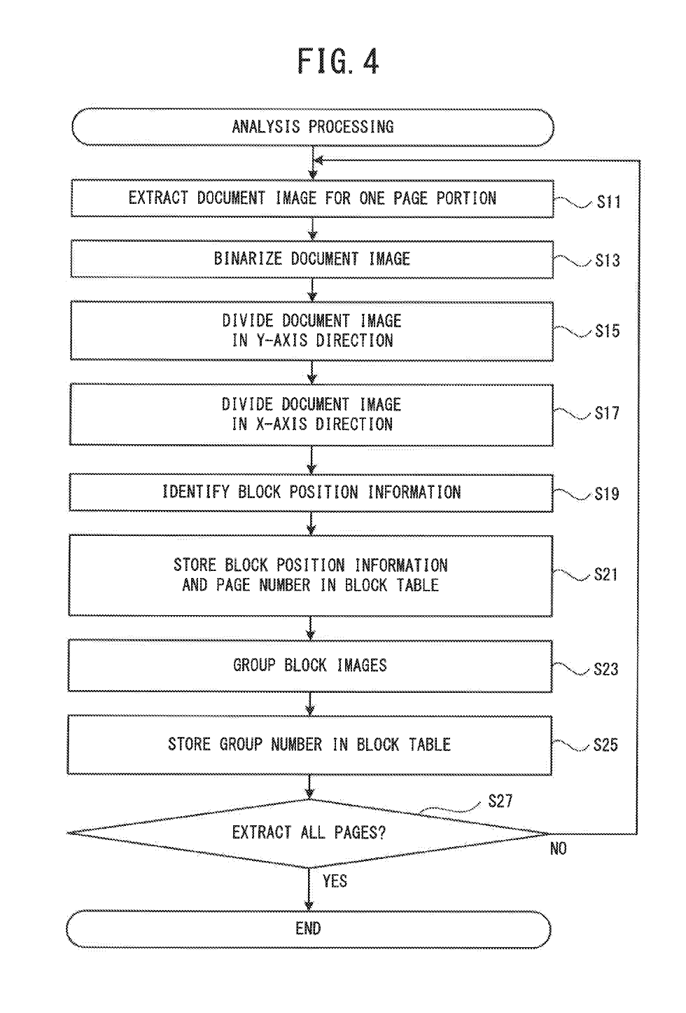

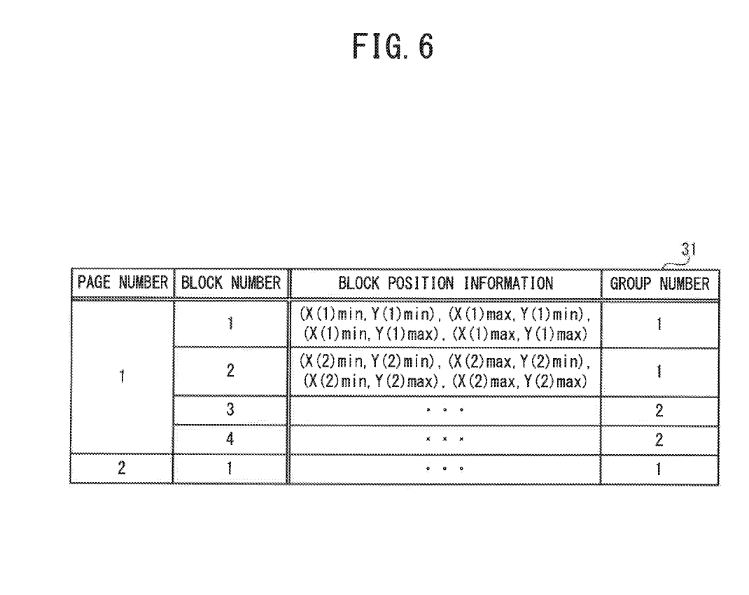

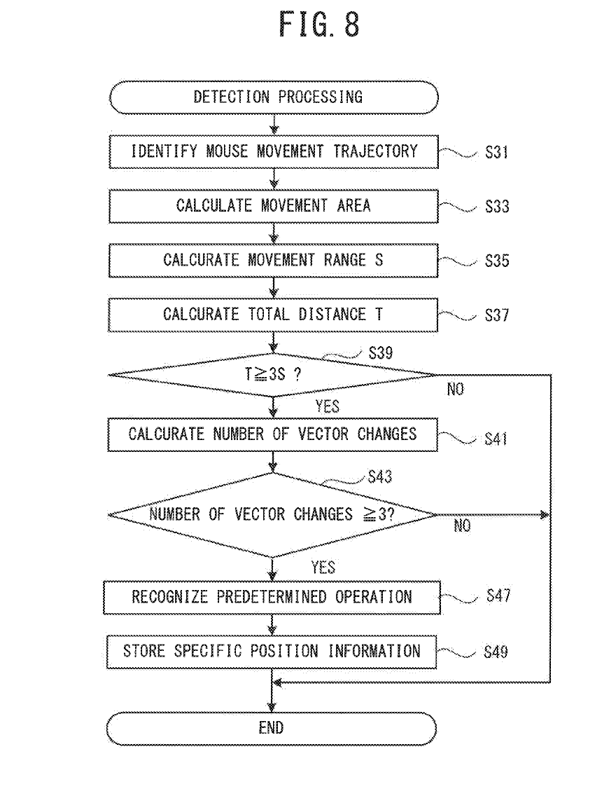

A program that causes the CPU 111 to perform analysis processing (refer to FIG. 4) and detection processing (refer to FIG. 8) and an operating system (OS) are stored in the HDD 114. At least one of document image files, which are electronic files including document images for a plurality of pages, is stored in the HDD 114. A block table 31 (refer to FIG. 6) is stored in the HDD 114. Address information of the server 13 (an IP address, URL or the like, for example) is stored in the HDD 114.

The communication I/F 115 is an interface (a local area network (LAN) card, for example) that is used to connect the first terminal 11 to the network 15. The CPU 111 transmits and receives data to and from the server 13 via the communication I/F 115. The drive device 120 is configured to read information stored in a storage medium 1201. The CPU 111 is configured to read a program stored in the storage medium 1201 using the drive device 120 and to store the program in the HDD 114. The camera 16 and the input portion 17 are connected to the external I/F 116. The input portion 17 includes a keyboard and a pointing device (a mouse, a touch panel or the like, for example). The display 117 is a liquid crystal display (LCD).

An electrical structure of the second terminal 12 will be described. The second terminal 12 includes a CPU 121 that controls the second terminal 12. The CPU 121 is electrically connected to a ROM 122, a RAM 123, an HDD 124, a communication I/F 125, a camera 1261, a touch panel 1262, the display 127, a speaker 128, a microphone 129, and a drive device 130. A boot program and a basic input/output system (BIOS), etc. are stored in the ROM 122. Temporary data of a timer and a counter, etc. are stored in the RAM 123.

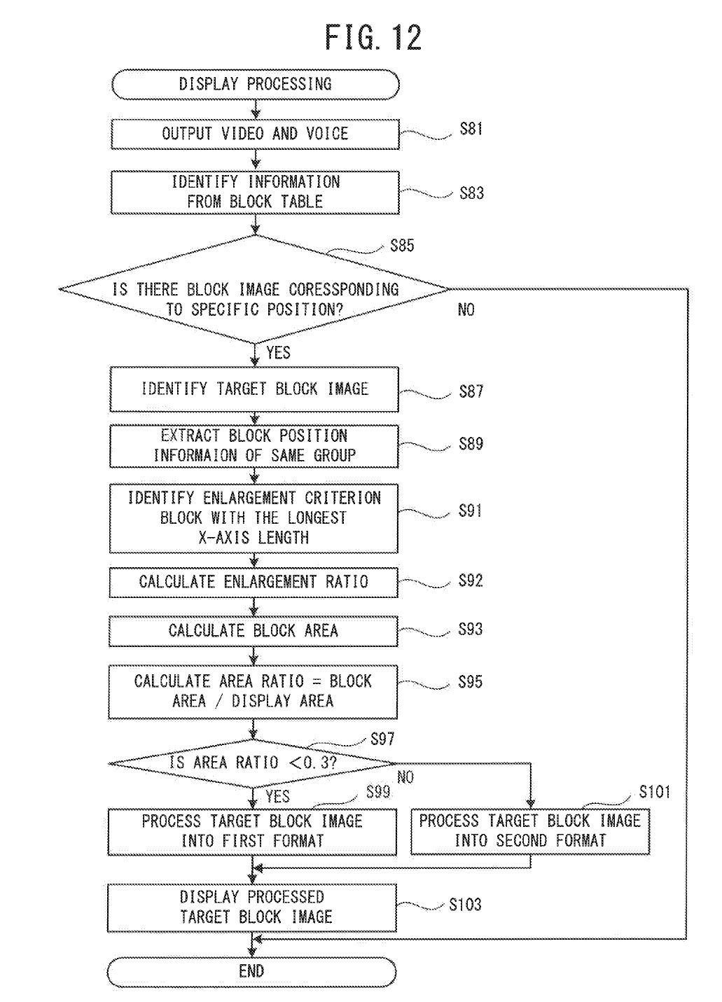

A program that causes the CPU 121 to perform display processing (refer to FIG. 12) and an OS are stored in the HDD 124. At least one of the document image files, which are received from the first terminal 11 via the server 13, and the block table 31 are stored in the HDD 124. The address information of the server 13 is stored in the HDD 124. The communication I/F 125 is an interface (a Wi-Fi communication modem or the like, for example) that allows the second terminal 12 to perform wireless communication via an access point (not shown in the drawings) that is connected to the network 15. The CPU 121 transmits and receives data to and from the server 13 via the communication I/F 125. The display 127 is an LCD. The drive device 130 is configured to read information stored in a storage medium 1301. The CPU 121 is configured to read a program stored in the storage medium 1301 using the drive device 130 and to store the program in the HDD 124.

Note that general-purpose processors may be used as the CPUs 111 and 121. The analysis processing and the detection processing need not necessarily be performed by the CPU 111 as described above in the example, but may be performed by another electronic component (an application specific integrated circuits (ASIC), for example). The display processing need not necessarily be performed by the CPU 121 as described above in the example, but may be performed by another electronic component (an ASIC, for example). The analysis processing, the detection processing, and the display processing may be performed in a distributed manner by a plurality of electronic devices (in other words, a plurality of CPUs). For example, a part of the analysis processing, the detection processing, and the display processing may be performed by a server connected to the network 15. A program may be stored in a storage device of the server connected to the network 15. In this case, the program may be downloaded from the server and may be stored in the HDDs 114 and 124, for example. That is, the program may be transmitted from the server to the first terminal 11 and the second terminal 12 in the form of transitory storage medium (e.g., transmission signal).

Programs that are used to perform the analysis processing, the detection processing, and the display processing, respectively, may be stored in the HDD 114 of the first terminal 11 and the HDD 124 of the second terminal 12. In this case, the first terminal 11 can be used as a participant's terminal device and the second terminal 12 can be used as a presenter's terminal device.

An electrical structure of the server 13 will be described. The server 13 includes a CPU 131 that controls the server 13. The CPU 131 is electrically connected to a ROM 132, a RAM 133, an HDD 134, a communication I/F 135, and a drive device 136. A boot program and a BIOS, etc. are stored in the ROM 132. Temporary data of a timer and a counter, etc. are stored in the RAM 133.

A program that causes the CPU 131 to perform processing, and an OS are stored in the HDD 134. At least one of the document image files, which are received from the first terminal 11, and the block table 31 are stored in the HDD 134. Address information of the first terminal 11 and the second terminal 12 is stored in the HDD 134. The communication I/F 135 is an interface (a LAN card, for example) that allows the server 13 to be connected to the network 15. The CPU 131 transmits and receives data to and from the first terminal 11 and the second terminal 12 via the communication I/F 135. The drive device 136 is configured to read information stored in a storage medium 1361. The CPU 131 is configured to read a program stored in the storage medium 1361 using the drive device 136 and to store the program in the HDD 134.

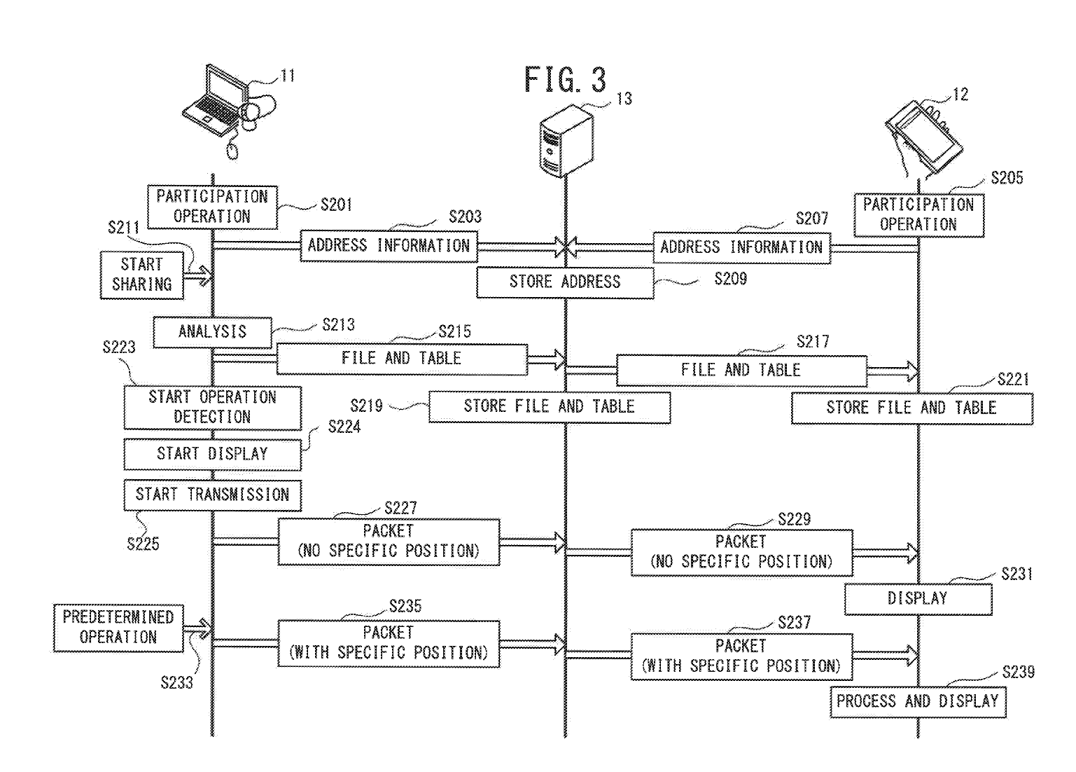

A communication sequence of the remote conference system 1 will be described with reference to FIG. 3. The presenter uses the first terminal 11 to perform an input operation for joining a conference via the input portion 17 (step S201). The first terminal 11 transmits the address information corresponding to the first terminal 11 to the server 13 via the network 15 (step S203). Meanwhile, the participant uses the second terminal 12 to perform an input operation for joining the conference via the touch panel 1262 (step S205). The second terminal 12 transmits the address information corresponding to the second terminal 12 to the server 13 via the network 15 (step S207). The server 13 associates the address information received respectively from the first terminal 11 and the second terminal 12 and stores the address information in the HDD 134 (step S209). After that, the server 13 identifies the address information of the first terminal 11 and the second terminal 12 by referring to the address information stored in the HDD 134 and relays data between the first terminal 11 and the second terminal 12.

The presenter performs an operation that specifies a specific document image file via the input portion 17 in order to start sharing the specific document image file with the participant (step S211). The first terminal 11 performs an analysis on the specified document image file (step S213). A specific analysis method will be described below.

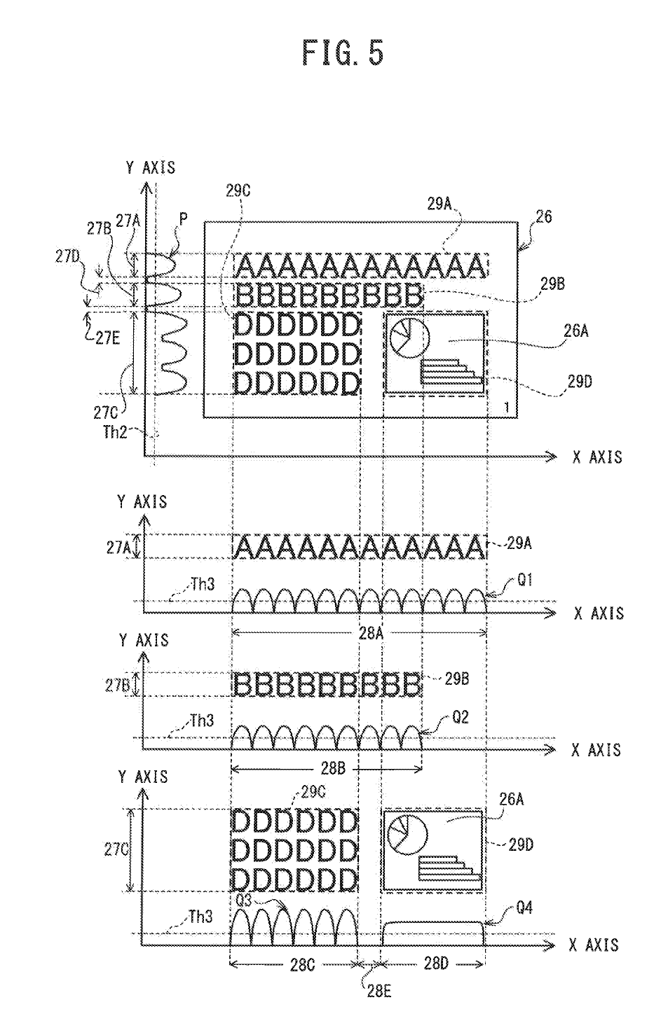

The analysis method for the document image file will be described with reference to FIG. 4 and FIG. 5. The analysis processing shown in FIG. 4 is started as a result of the CPU 111 of the first terminal 11 reading a program from the HDD 114 and executing the program at step S213 (refer to FIG. 3). Hereinafter, a horizontal direction of the document image file is referred to as an X-axis direction and a vertical direction of the document image file is referred to as a Y-axis direction (refer to FIG. 5). First, the CPU 111 sequentially extracts document images included in the document image file specified at step S211 (refer to FIG. 3), one page at a time (step S11). The CPU 111 binarizes the extracted one page of the document image (step S13).

For example, with respect to each of a plurality of pixels that form the extracted one page of the document image, the CPU 111 identifies a luminance value that is the largest among luminance values of RGB components of each of the pixels, as an image density. The CPU 111 compares the identified image density with a predetermined threshold value Th1. Note that the CPU 111 may extract pixels at predetermined intervals from among the plurality of the pixels that form the document image, and may identify the image density of the extracted pixels. The CPU 111 may identify a total luminance value of the RGB components of each of the pixels as the image density. The threshold value Th1 may be stored in the HDD 114 in advance as a fixed value or may be dynamically set based on luminance information of the page extracted at step S11. The CPU 111 assigns 1 to a pixel that has the image density equal to or larger than the threshold value Th1 and assigns 0 to a pixel that has the image density smaller than the threshold value Th1. By this, the CPU 111 obtains a two-dimensional (2D) distribution of “1” or “0” from the one page of the document image.

In the above-described processing, when black characters are included in the extracted one page of the document image, the CPU 111 may perform luminance reversal processing on the document image before binarizing the document image. The CPU 111 may binarize the luminance-reversed document image. Note that examples of the document image including the black characters include a document image in which font data are embedded in an electronic file, such as an image created by an application for text editing. These examples also include a document image in which the luminance of characters recognized by optical character recognition (OCR) is lower than that of a surrounding area.

Based on the obtained 2D distribution of “1” or “0,” the CPU 111 calculates an accumulated value of “1” for each of components that share the same position in the Y-axis direction. This will be described more specifically with reference to FIG. 5. A curved line P shown to the right of the Y-axis in FIG. 5 indicates changes in the accumulated value of “1” calculated for each of the components that share the same position in the Y-axis direction. The curved line P indicates that the accumulated value of “1” is larger as it moves further in the right direction. In a document image 26 of one page, the accumulated value of “1” is large at positions 27A and 27B of the Y-axis direction of respective lines that include characters A and B, as sections displaying the characters A and B have a higher image density. On the other hand, the accumulated value of “1” is small at a position 27D of the Y-axis direction, which corresponds to a line space between the characters A and B, as the image density is small at the position 27D at which no characters are displayed.

As shown in FIG. 4, the CPU 111 divides the document image in the Y-axis direction based on a comparison result between the calculated accumulated value and a predetermined threshold value Th2 (step S15). For example, when a position of the Y-axis direction that has an accumulated value smaller than the threshold value Th2 is continuous for a predetermined length in the Y-axis direction, the CPU 111 divides the document image of one page in the Y-axis direction at the continuous position. For example, as shown in FIG. 5, the accumulated value is smaller than the threshold value Th2 at the position 27D and at a position 27E (a line space between the characters B and characters D) of the Y-axis direction, respectively. Therefore, the document image 26 is divided at the positions 27D and 27E in the Y-axis direction and divided into sections corresponding to the position 27A, the position 27B, and a position 27C of the Y-axis direction. Of the document image 26, the respective sections divided in the Y-axis direction at step S15 are referred to as divided elements.

Next, based on the obtained 2D distribution of “1” and “0”, the CPU 111 calculates the accumulated value of “1” for each of components that share the same position in the X-axis direction with respect to each of the divided elements divided in the Y-axis direction at step S15. This will be described more specifically with reference to FIG. 5. Curved lines Q1 to Q4 shown above the X-axis in FIG. 5 respectively indicate changes in the accumulated value that is calculated for each of the components that share the same position in the X-axis direction. The curved lines Q1 to Q4 indicate that the accumulated value of “1” is larger as it moves further in the upward direction.

As shown in FIG. 4, based on a result of a comparison between the calculated accumulated value and a predetermined threshold value Th3, the CPU 111 divides the document image in the X-axis direction (step S17). For example, when a position of the X-axis direction that has the accumulated value smaller than the threshold value Th3 is continuous for a predetermined length in the X-axis direction, the CPU 111 divides the document image of the one page (more specifically, the document image divided in the Y-axis direction at step S15) in the X-axis direction at the continuous position. For example, as shown in FIG. 5, the divided element that is divided into the section corresponding to the position 27A of the Y-axis direction is further divided into a section corresponding to a position 28A of the X-axis direction based on the curved line Q1. An image corresponding to the position 27A of the Y-axis direction and the position 28A of the X-axis direction is referred to as a block image 29A.

Similarly, the divided element that is divided into the section corresponding to the position 27B of the Y-axis direction is further divided into a section corresponding to a position 28B of the X-axis direction, based on the curved line Q2. An image corresponding to the position 27B of the Y-axis direction and the position 28B of the X-axis direction is referred to as a block image 29B. The divided element that is divided into the section corresponding to the position 27C of the Y-axis direction is divided in the X axis direction at a position 28E of the X-axis direction and further divided into sections corresponding to positions 28C and 28D of the X-axis direction, based on the curved lines Q3 and Q4. An image corresponding to the position 27C of the Y-axis direction and the position 28C of the X-axis direction is referred to as a block image 29C. An image corresponding to the position 27C of the Y-axis direction and the position 28D of the X-axis direction is referred to as a block image 29D.

Note that, although each of the curved lines Q1 to Q4, which indicate changes in the accumulated value, indicate the accumulated values smaller than the threshold value Th3 at positions corresponding to line spaces between characters A, B, and D in the X-axis direction, the document image 26 is not divided in this instance, as each of the above-described accumulated values is not continuous for the predetermined length in the X-axis direction.

As shown in FIG. 4, the CPU 111 identifies block position information for each of the block images divided at step S17 (step S19). The block position information is coordinate information indicating positions of four apexes of a rectangular shape that indicates a block image. The CPU 111 associates a block number and a page number of the page extracted at step S11 with the identified block position information and stores the associated information in the block table 31 (step S21). The block number is a number that identifies the block image.

The block table 31 will be described with reference to FIG. 6. The block table 31 is one example of the block information that is stored in a table format. For example, the block information includes the page number, the block number, the block position information, and a group number that will be described below. Thus, the block table 31 stores the page number, the block number, the block position information, and the group number. The block position information (X(i)min, Y(i)min), (X(i)max, Y(i)min), (X(i)min, Y(i)max), and (X(i)max, Y(i)max) (i=1, 2 . . . ) respectively indicates the coordinate information of the respective apexes located at the bottom left, bottom right, top left, and top right of the rectangular shape that indicates the block image. Block numbers “1” to “4,” which correspond to a page number “1,” correspond to the block images 29A to 29D illustrated in FIG. 5, respectively. Note that the group number is not stored in the block table 31 at step S21. The group number is stored in the block table 31 at step S23 that will be described below. One set of the block information is created for each of the document image files and stored in the HDD 114. The block table 31 illustrated in FIG. 6 corresponds to a document image file named “sample.ppt.”

As shown in FIG. 4, based on the block position information identified at step S19, the CPU 111 calculates respective lengths in the Y-axis direction of the plurality of block images that divide up the document image of the one page. The CPU 111 groups the block images that have a similar calculated length in the Y-axis direction (step S23). For example, of the plurality of the block images, the CPU 111 groups the block images whose difference in length is equal to or less than ±10% in the Y-axis direction. The CPU 111 associates the respective block images, which are grouped together, with a common group number, and stores the associated information in the block table 31 (refer to FIG. 6) (step S25).

In the example shown in FIG. 5, the respective lengths in the Y-axis direction of the block images 29A and 29B are similar to each other. The respective lengths in the Y-axis direction of the block images 29C and 29D are similar to each other. Therefore, as shown in FIG. 6, a common group number “1” is associated with the block number “1” (the block image 29A) and the block number “2” (the block image 29B) of the block table 31, respectively. A common group number “2” is associated with the block number “3” (the block image 29C) and the block number “4” (the block image 29D) of the block table 31, respectively.

As shown in FIG. 4, the CPU 111 determines whether document images of all pages included in the document image file have been extracted at step S11 (step S27). When the document images of all the pages have not been extracted at step S11 (no at step S27), the CPU 111 returns the processing to step S11. Next, the CPU 111 extracts pages that have not yet been extracted and repeats the processing. When the document images of all the pages have been extracted at step S11 (yes at step S27), the CPU 111 terminates the analysis processing. By the above-described analysis processing, the CPU 111 can easily identify the plurality of the block images from the document image and can also group the plurality of the block images with ease.

As shown in FIG. 3, analysis is performed on the document image file at step S213 (refer to FIG. 4 and FIG. 5), and after the block table 31 (refer to FIG. 6) is created, the first terminal 11 transmits the document image file and the block table 31 to the server 13 (step S215). The server 13 receives the document image file and the block table 31 and stores them in the HDD 134 (step S219). The server 13 transmits the document image file and the block table 31, which are received from the first terminal 11, to the second terminal 12 (step S217). The second terminal 12 receives the document image file and the block table 31 and stores them in the HDD 124 (step S221).

Note that, in some cases, the server 13 newly receives address information from another second terminal 12 that is different from the second terminal 12 that transmits the address information at step S207. In this case, the server 13 transmits the document image file and the block table 31, which are stored in the HDD 134, to the second terminal 12 that has newly transmitted the address information to the server 13, and causes that second terminal 12 to join the conference.

The first terminal 11 repeatedly calculates relative positions of the pointing device, which is included in the input portion 17, by obtaining a movement amount that is continuously output from the pointing device. The first terminal 11 starts processing that detects a predetermined operation, which is performed via the pointing device, based on the relative positions of the pointing device that are calculated per unit time (step S223). The predetermined operation is an operation that highlights a specific position in the document image of one page, which is displayed in the first area 211 of the display screen 21 displayed on the first terminal 11. Below, an example will be explained in which a mouse is used as the pointing device.

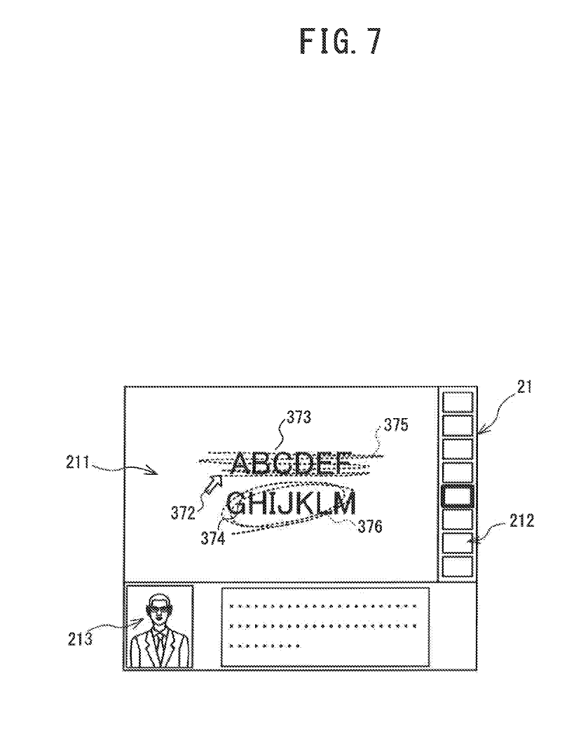

For example, as shown in FIG. 7, it is assumed that the presenter operates the mouse so that a cursor 372 moves to and fro to the left and right over characters 373 “ABCDEF,” of the document image of one page that is displayed in the first area 211. A trajectory 375 indicates a trajectory of a movement of the cursor 372 that has moved to and fro to the left and right over the characters 373. Alternatively, it is assumed that the presenter operates the mouse such that the cursor 372 draws circles repeatedly over characters 374 “GHIJKLM,” of the document image. A trajectory 376 indicates a trajectory of the movement of the cursor 372 that has moved over the characters 374 so as to draw circles repeatedly thereover. These operations are general operations performed by the presenter when the presenter wants to highlight the characters 373 and 374 respectively. When the above-described operation is performed using the mouse, the first terminal 11 determines that the above-described predetermined operation has been performed.

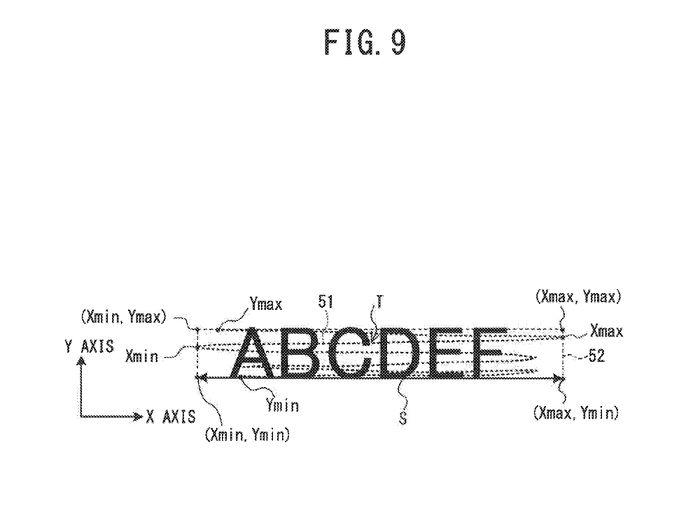

The detection processing of the predetermined operation will be described with reference to FIG. 8 and FIG. 9. The detection processing shown in FIG. 8 is started as a result of the CPU 111 of the first terminal 11 reading a program from the HDD 114 and executing the program at step S223 (refer to FIG. 3). After that, the CPU 111 repeatedly performs the detection processing at a predetermined frequency. To describe the detection processing in FIG. 8 more specifically, an example will be described below in which the mouse is operated so that the cursor 372 moves over a trajectory 51 shown in FIG. 9 within a unit time. The trajectory 51 of the movement of the cursor 372 is rephrased as “the trajectory 51 of the movement of the mouse.” The left-right direction in FIG. 9 corresponds to the X-axis direction and the vertical direction in FIG. 9 corresponds to the Y-axis direction.

As shown in FIG. 8, the CPU 111 identifies a plurality of pieces of coordinate information (X, Y), which indicate relative positions of the mouse, based on movement amounts that are continuously output from the mouse. More specifically, when an operation is performed with respect to the mouse, the CPU 111 identifies the plurality of pieces of the coordinate information (X, Y) that indicate positions on the trajectory 51. The CPU 111 identifies the trajectory 51 of the movement of the mouse based on chronological changes of the coordinate information (X, Y) per unit time (S31). The CPU 111 calculates a movement area 52 of the mouse (refer to FIG. 9) based on the identified trajectory 51 of the movement (step S33). In an example shown in FIG. 9, the identified plurality of pieces of coordinate information (X, Y) include a minimum value (Xmin) and a maximum value (Xmax) of the X-axis direction and a minimum value (Ymin) and a maximum value (Ymax) of the Y-axis direction. The movement area 52 corresponds to an area surrounded by four points, namely, (Xmin, Ymin), (Xmax, Ymin), (Xmax, Ymax), and (Xmin, Ymax).

As shown in FIG. 8, the CPU 111 calculates a movement range S (=Xmax−Xmin) (refer to FIG. 9) of the X-axis direction per unit time (step S35). The CPU 111 calculates a total distance T (refer to FIG. 9) of the trajectory 51 per unit time (step S37). The CPU 111 determines whether or not the total distance T calculated at step S37 is equal to or greater than three times the movement range S calculated at step S35 (step S39). When the total distance T is less than three times the movement range S (no at step S39), the CPU determines that the predetermined operation has not been performed and terminates the detection processing.

In the example shown in FIG. 9, the total distance T is equal to or greater than three times the movement range S (yes at step S39). In this case, the CPU 111 identifies a traveling direction vector of the movement trajectory 51, based on the trajectory 51 (refer to FIG. 9) of the movement of the mouse identified at step S31. The CPU 111 calculates a number of polarity changes with respect to an X-axis direction component of the identified travelling direction vector (S41). The CPU 111 determines whether the calculated number of the polarity changes is equal to or greater than 3 (step S43). In the example shown in FIG. 9, the trajectory 51 moves to and fro in the X-axis direction three times in total, the polarity changes three times from the positive (the right direction in FIG. 9) to the negative (the left direction in FIG. 9), and the polarity changes twice from the negative to the positive. Therefore, 5 (=3+2) is calculated as a result of the number of the polarity changes. In this case, as the calculated number of the polarity changes is equal to or greater than 3 (yes at step S43), the CPU 111 advances the processing to step S47.

As shown in FIG. 8, the CPU 111 recognizes the operation performed with respect to the mouse as the predetermined operation (step S47). The CPU 111 stores the four pieces of coordinate information ((Xmin, Ymin), (Xmax, Ymin), (Xmax, Ymax), and (Xmin, Ymax)), which indicate the movement area 52 (refer to FIG. 9) identified at step S33, in the RAM 113 as specific position information (step S49). The CPU 111 terminates the detection processing. On the other hand, when the calculated number of the polarity changes is less than 3 (no at step S43), the CPU 111 determines that the predetermined operation has not been performed and terminates the detection processing. By the above-described detection processing, the CPU 111 can recognize a general highlighting operation performed by the presenter using the mouse, as the predetermined operation that specifies the specific position on the document image.

As shown in FIG. 3, when the operation that designates the specific document image file is performed at step S211, the first terminal 11 starts processing that displays the display screen 21 on the display 117 (step S224). For example, the first terminal 11 displays thumbnails of a plurality of document images, which are included in the specific document image file, in the second area 212 of the display screen 21. When the first terminal 11 accepts an input operation that selects one of the plurality of the thumbnails via the input portion 17, the first terminal 11 displays the selected thumbnail with the thumbnail bordered with a bold line. The first terminal 11 displays a document image of a page corresponding to the selected thumbnail in the first area 211 of the display screen 21. The first terminal 11 displays video captured by the camera 16 in the third area 213.

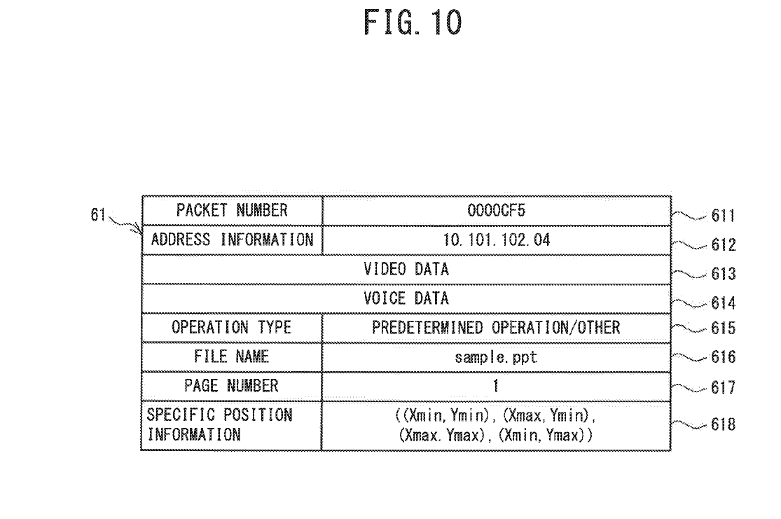

The first terminal 11 starts processing that periodically transmits a packet 61 (refer to FIG. 10) to the second terminal 12 via the server 13 (step S225). Data included in the packet 61 will be described with reference to FIG. 10. A packet number 611, address information 612, video data 613, voice data 614, an operation type 615, a file name 616, a page number 617, and specific position information 618 are stored in the packet 61. The packet number 611 is an identification number that is used to identify the packet 61. The address information 612 is the address information of the server 13 to which the packet 61 is to be transmitted. The video data 613 are video data captured by the camera 16 connected to the first terminal 11. The voice data 614 are voice data collected by the microphone 119 provided in the first terminal 11.

The operation type 615 is information that indicates whether or not the presenter has performed the predetermined operation via the input portion 17. When the CPU 111 determines that the predetermined operation has been performed based on the detection processing (refer to FIG. 8), the CPU 111 stores information indicating “predetermined operation detected” in the operation type 615. The file name 616 is a name of the specific document image file designated at step S211. The page number 617 indicates a page number corresponding to the selected thumbnail, of the plurality of thumbnails displayed in the second area 212 (in other words, a page number of the document image displayed in the first area 211). The specific position information 618 is the specific position information stored in the RAM 113 by the detection processing (refer to FIG. 8). In other words, The specific position information 618 is information indicating the specific position at which the predetermined operation has been performed.

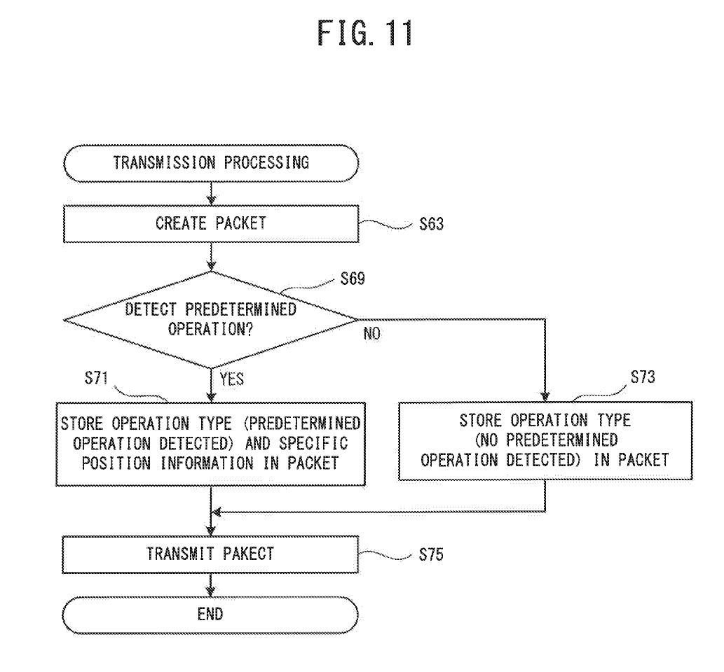

Transmission processing of the packet 61 will be described with reference to FIG. 11. The transmission processing is started as a result of the CPU 111 of the first terminal 11 reading a program from the HDD 114 and executing the program at step S225 (refer to FIG. 3). The CPU 111 periodically performs the transmission processing to periodically transmit the packet 61 to the second terminal 12 via the server 13.

First, the CPU 111 creates the packet 61 in the following manner (step S63). The CPU 111 updates a packet number variable, which is stored in the RAM 113, by adding “1” thereto and stores the variable in the packet number 611 of the packet 61. The CPU 111 reads the address information of the server 13 from the HDD 114 and stores the address information in the address information 612 of the packet 61. The CPU 111 obtains imaging data from the camera 16 and stores the data in the video data 613 of the packet 61. The CPU 111 obtains voice data from the microphone 119 and stores the data in the voice data 614 of the packet 61. The CPU 111 stores a file name of the document image file, which includes the document image of one page displayed in the first area 211 of the display screen 21, in the file name 616 of the packet 61. The CPU 111 stores a page number of the document image of one page, which is displayed in the first area 211 of the display screen 21, in the page number 617 of the packet 61.

The CPU 111 determines whether or not the detection processing (FIG. 8) has detected the predetermined operation (step S69). The CPU 111 determines that the predetermined operation has been detected when the specific position information is stored in the RAM 113 (yes at step S69). The CPU stores the information indicating “predetermined operation detected” in the operation type 615 of the packet 61. The CPU 111 reads the specific position information stored in the RAM 113 and stores the information in the specific position information 618 of the packet 61 (step S71). After reading the specific position information from the RAM 113, the CPU 111 deletes the specific position information from the RAM 113 and advances the processing to step S75.

On the other hand, the CPU 111 determines that the predetermined operation has not been detected when the specific position information is not stored in the RAM 113 (no at step S69). The CPU 111 stores information indicating “no predetermined operation detected” in the operation type 615 of the packet 61 (step S73). The CPU 111 does not store any information in the specific position information 618 of the packet 61 and advances the processing to step S75. The CPU 111 transmits the packet 61 to the server 13 (step S75). The CPU 111 terminates the transmission processing.

As shown in FIG. 3, when the predetermined operation is not performed, the first terminal 11 transmits the packet 61 that does not include the specific position information 618 to the server 13. The server 13 receives the packet 61 (step S227). The server 13 identifies the address information of the second terminal 12 based on the address information stored in the HDD 134 at step S209. The server 13 changes the address information 612 of the packet 61 to the address information of the second terminal 12. The server 13 transmits the packet 61, in which the address information 612 has been changed, to the second terminal 12 (step S229). The second terminal 12 receives the packet 61.

Based on the received packet 61, the second terminal 12 displays the display screen 21 on the display 127 in a display mode corresponding to the operation mode (step S231). When the second terminal 12 operates in the first mode, the second terminal 12 identifies the file name and the page number of the document image file based on the file name 616 and the page number 617 of the received packet 61. The second terminal 12 obtains the document image file of the identified file name, from the one or more document image files stored in the HDD 124. The second terminal 12 displays, in the second area 212 of the display screen 21, the thumbnails of the document images of a plurality of pages, which are included in the obtained document image file. Of the thumbnails of the document images of the plurality of pages that are displayed in the second area 212, the second terminal 12 displays the thumbnail of the identified page number bordered with a bold line. The second terminal 12 obtains the document image of the identified page number from the obtained document image file. The second terminal 12 displays the obtained document image in the first area 211 of the display screen 21. The second terminal 12 displays video in the third area 213 of the display screen 21, based on the video data 613 of the received packet 61.

On the other hand, when the second terminal 12 operates in the second mode, the second terminal 12 identifies the file name of the document image file based on the received file name 616. The second terminal 12 obtains the document image file of the identified file name from the one or more document image files stored in the HDD 124. The second terminal 12 displays, in the second area 212 of the display screen 21, the thumbnails of the document images of the plurality of pages, which are included in the obtained document image file. The second terminal 12 displays, in the first area 211 of the display screen 21, the document image of the page corresponding to the thumbnail selected via the touch panel 1262.

Note that, regardless of the operation mode being operated, the second terminal 12 outputs sound from the speaker 128 based on the voice data 614 of the packet 61.

An example will be described below in which the presenter, who uses the first terminal 11, performs the predetermined operation with respect to a specific position on the document image displayed in the first area 211 of the display screen 21 (step S233). Based on the detection processing (refer to FIG. 8), the first terminal 11 determines that the predetermined operation has been performed. The first terminal 11 transmits the packet 61, which includes the operation type 615 that indicates “predetermined operation detected” and the specific position information 618, to the server 13 (step S235). The server 13 transmits the received packet 61 to the second terminal 12 (step S237). The second terminal 12 receives the packet 61 from the server 13. In this case, unlike the case at step S231, the second terminal 12 processes the document image and then displays the document image (step S239).

The display processing will be described with reference to FIG. 12. The display processing is started as a result of the CPU 121 of the second terminal 12 reading a program from the HDD 124 and executing the program at step S239 (refer to FIG. 3).

The CPU 121 displays video in the third area 213 of the display screen 21 based on the video data 613 of the received packet 61. Note that the term “the CPU 121 displays” may include a configuration that the CPU 121 transmits an instruction to (i.e., cause) the display 117 to display data included in the instruction. The CPU 121 outputs sound from the speaker 128 based on the voice data 614 of the received packet 61 (step S81). The CPU 121 identifies the block table 31 corresponding to the file name 616 included in the received packet 61, from the one or more block tables 31 stored in the HDD 124 (step S83). From the identified block table 31, the CPU 121 further identifies information corresponding to the page number 617 included in the received packet 61 (step S83). In other words, the CPU 121 identifies the block number, the block position information, and the group number that are shown in FIG. 6.

Based on the information identified by referring to the block table 31 at step S83, the CPU 121 determines whether there is a block image corresponding to the specific position, which is indicated by the specific position information 618 included in the received packet 61, in the following manner (step S85). The CPU 121 identifies an area identified by the specific position information 618 included in the packet 61 as a specific position area. The CPU 121 identifies areas respectively identified by a plurality of pieces of block position information, which are identified by referring to the block table 31 at step S83, as one or more block position areas. The CPU 121 determines whether or not there is one or more of the block position areas including an area overlapping with the specific position area, among the identified one or more block position areas. When there is no block position area including the area overlapping with the specific position area among the identified one or more block position areas, the CPU 121 determines that there is no block image corresponding to the specific position (no at step S85) and terminates the display processing.

When there are the one or more block position areas including the area overlapping with the specific position area, the CPU 121 determines that there is a block image corresponding to the specific position (yes at step S85). In this case, the CPU 121 identifies, as a target block image, the block position area that has the largest area overlapping with the specific position area, among the one or more block position areas that include the area overlapping with the specific position area (step S87).

Of the block table 31, the CPU 121 extracts all the block position information associated with the same group number as the group number corresponding to the block position information of the target block image identified at step S87 (step S89). The CPU 121 identifies the block position information of an enlargement criterion block among the block images respectively corresponding to all the block position information extracted at step S89 (step S91). The enlargement criterion block is a block image having the longest length in the X-axis direction among the block images corresponding to all the block position information extracted at step S89.

The CPU 121 calculates a magnification factor (step S92). An example of the magnification factor may be a magnification ratio that is required to extend the X-axis direction length of the enlargement criterion block up to a horizontal (X-axis direction) length of the first area 211 of the display screen 21, based on the block position information identified at step S91. The CPU 121 calculates a block area (step S93). The block area is an area of the target block image when the target block image identified at step S87 is enlarged by the magnification factor calculated at step S92 while keeping a ratio between the length in the X-axis direction and the length in the Y-axis direction constant.

The CPU 121 calculates an area ratio by dividing the calculated block area by an area of the first area 211 of the display screen 21 (step S95). The CPU 121 compares the calculated area ratio with a predetermined threshold value (“0.3”, for example) (step S97). When the area ratio is less than “0.3” (yes at step S97), the CPU 121 processes the target block image so that the target block image is displayed in a first format that will be described below (step S99). The CPU advances the processing to step S103. When the area ratio is equal to or greater than “0.3” (no at step S97), the CPU 121 processes the target block image so that the target block image is displayed in a second format that will be described below (step S101). The CPU 121 advances the processing to step S103. Note that the predetermined threshold value is not limited to “0.3.”

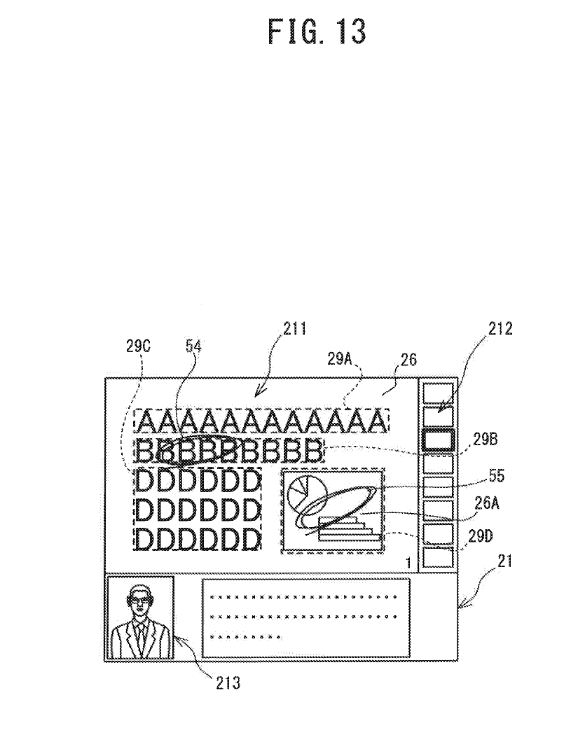

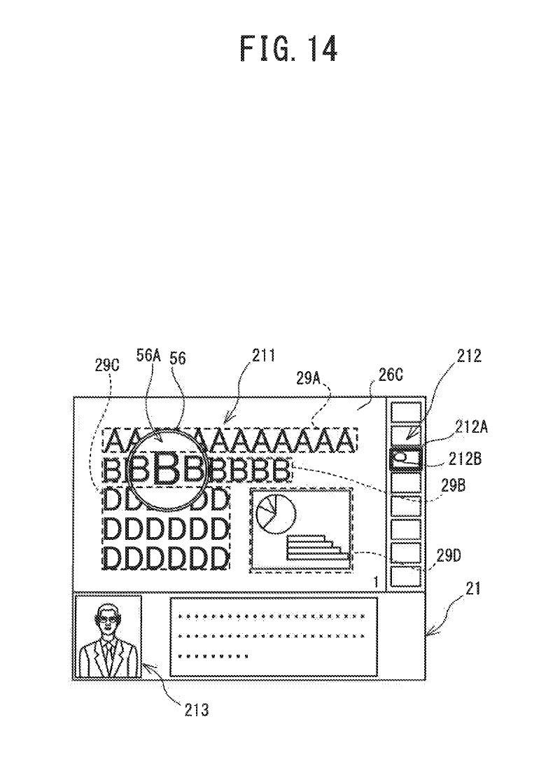

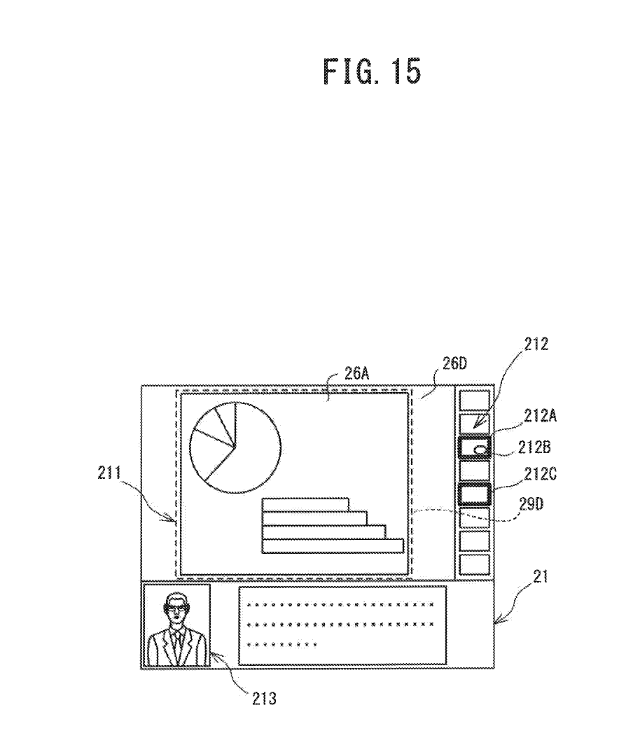

A more specific explanation will be made below with reference to FIG. 13, FIG. 14, and FIG. 15. As shown in FIG. 13, an example will be described in which, on the first terminal 11, the presenter has performed the predetermined operation on a part of the block image 29B (the characters B) of the document image 26 displayed in the first area 211 of the display screen 21. A trajectory 54 indicates a trajectory of the mouse on which the predetermined operation has been performed. In this case, the CPU 111 of the first terminal 11 creates the packet 61 (refer to FIG. 10) that includes the operation type 615 indicating “predetermined operation detected,” “sample.ppt” as the file name 616, “1” as the page number 617, and the specific position information 618 (step S63 and step S71). The specific position information 618 includes the coordinate information indicating positions of the trajectory 54. The CPU transmits the created packet 61 to the second terminal 12 via the server 13 (step S75). The second terminal 12 receives the packet 61.

Based on the file name 616, the page number 617, and the specific position information 618 included in the received packet 61, the CPU 121 of the second terminal 12 identifies corresponding information by referring to the block table 31 stored in the HDD 124. In other words, the CPU 121 identifies the plurality of block numbers “1” to “4” shown in FIG. 6, the block position information corresponding to each of the block numbers “1” to “4,” and the group numbers “1” and “2”. The CPU 121 identifies the block image 29B corresponding to the specific position indicated by the specific position information 618 included in the received packet 61 as the target block image (step S87).

The CPU 121 identifies the block image 29A, which belongs to the same group (the group number “1”) as the target block image (the block image 29B) and which has the longest length in the X-axis direction, as the enlargement criterion block (step S89 and step S91). The CPU 121 calculates the magnification factor based on the length of the enlargement criterion block (the block image 29A) in the X-axis direction (step S92). The CPU 121 calculates the block area based on a case in which the target block image (the block image 29B) is enlarged by the calculated magnification factor (step S93). The CPU 121 calculates the area ratio based on the block area and compares the calculated area ratio with “0.3” (step S97). In this case, as the area ratio is smaller than “0.3” (yes at step S97), the CPU 121 processes the target block image (the block image 29B) into the first format (step S99).

FIG. 14 shows a document image 26C that includes the target block image (the block image 29B) that has been processed so as to be displayed in the first format. In the document image 26C, a magnifying glass 56 is displayed on a section of the block image 29B that corresponds to the specific position indicated by the specific position information 618. A part of the block image 29B that is located inside the magnifying glass 56 is enlarged by a predetermined magnification factor. In other words, an adjacent area 56A that is the specific position on which the predetermined operation has been performed by the presenter and a position that is adjacent to the specific position are enlarged by the predetermined magnification factor.

On the other hand, as shown in FIG. 13, an example will be described in which, on to the first terminal 11, the presenter has performed the predetermined operation on a part of the block image 29D (a drawing pattern 26A), of the document image 26 displayed in the first area 211 of the display screen 21. A trajectory 55 indicates a trajectory of the mouse on which the predetermined operation has been performed. In this case, the CPU 111 of the first terminal 11 creates the packet 61 (refer to FIG. 10) that includes, the operation type 615 indicating “no predetermined operation detected,” “sample.ppt” as the file name 616, “1” as the page number 617, and the specific position information 618 (step S63 and step S71). The specific position information 618 includes the coordinate information indicating positions of the trajectory 55. The CPU transmits the created packet 61 to the second terminal 12 via the server 13 (step S75). The second terminal 12 receives the packet 61.

In the same manner as described above, the CPU 121 of the second terminal 12 identifies the block image 29D corresponding to the specific position indicated by the specific position information 618 of the received packet 61 as the target block image (step S87). The CPU 121 identifies the block image 29C, which belongs to the same group (the group number “2”) as the target block image (the block image 29D) and which has the longest length in the X-axis direction, as the enlargement criterion block (step S89 and step S91). The CPU 121 identifies the magnification factor based on the length of the enlargement criterion block (the block image 29C) in the X-axis direction (step S92). The CPU 121 calculates the block area based on the identified enlargement and the target block image (the block image 29D) (step S93). The CPU 121 calculates the area ratio based on the block area and compares the calculated area ratio with “0.3” (step S97). In this case, as the area ration is equal to or greater than “0.3” (no at step S97), the CPU 121 processes the target block image (the block image 29D) into the second format (step S101).

FIG. 15 shows a document image 26D that includes the target block image (the block image 29D) that has been processed so as to be displayed in the second format. In the document image 26D, the entire block image 29D is enlarged by the magnification factor identified at step S92 and is displayed in the first area 211 of the display screen 21. In the first area 211, only the enlarged document image 26D is displayed.

As shown in FIG. 12, the CPU 121 displays the target block image, which has been processed so as to be displayed in the first format or the second format, in the display 127 in a format corresponding to the operation mode in the following manner (step S103). When the second terminal 12 operates in the first mode, the document image of the same page as that of the document image displayed on the first terminal 11 is displayed in the first area 211 of the display screen 21. Therefore, the page number 617 included in the packet 61 received from the first terminal 11 matches the page number of a displayed target image. The displayed target image is a document image that is being displayed in the first area 211 of the display screen 21 at a time when the packet 61 is received. The CPU 121 determines whether the page number 617 included in the received packet 61 matches the page number of the displayed target image. When the page number 617 matches the page number of the displayed target image, the CPU 121 displays the document image including the target block image, which has been processed at step S99, or the target block image, which has been processed at step S101, in the first area 211 for a predetermined time period in place of the displayed target image.

In the second area 212 of the display screen 21, the CPU 121 causes a thumbnail 212A (refer to FIG. 14 and FIG. 15) that corresponds to the displayed target image to be displayed with a bold line border. Further, the CPU 121 displays a circle 212B (refer to FIG. 14 and FIG. 15) in the thumbnail 212A at a position corresponding to a section on which the presenter has performed the predetermined operation. In other words, the CPU 121 displays the circle 212B in the thumbnail 212A at the specific position indicated by the specific position information 618. After displaying the document image including the target block image, which has been processed at step S99, or the target block image, which has been processed at step S101, in the first area 211 for the predetermined time period, the CPU 121 restores a display state to an original state by displaying the displayed target image in the first area 211. The CPU 121 terminates the display processing.

When the second terminal 12 operates in the second mode, a document image of a different page from that of the document image displayed on the first terminal 11 may be displayed in the first area 211 of the display screen 21 in some cases. When the CPU 121 determines that the page number 617 included in the packet 61 matches the page number of the displayed target image, the CPU 121 performs the same display processing as performed in the above-described first mode.

On the other hand, when the page number 617 included in the packet 61 received from the first terminal 11 is different to the page number of the displayed target image, the document image of the different page from that of the document image displayed on the first terminal 11 is displayed in the first area 211. In this case, firstly, the CPU 121 displays the document image of the page number 617 included in the received packet 61 for a predetermined time period while causing the document image to overlap with a part of the displayed target image. Next, the CPU 121 displays the document image including the target block image, which has been processed at step S99, or the target block image, which has been processed at step S101, for the predetermined time period while causing the document image or the target block image to overlap with a part of the displayed target image.

Further, in the second area 212 of the display screen 21, the CPU 121 causes a thumbnail that corresponds to the document image including the target block image, which is displayed in a state of being overlapped with a part of the displayed target image, to be displayed with a bold line border, as well as causing the thumbnail that corresponds to the displayed target image to be displayed with a bold line border. In one of the thumbnails bordered with the bold line, the CPU 121 displays a circle at a position corresponding to the section on which the presenter has performed the predetermined operation. In other words, the CPU 121 displays the circle in the thumbnail at the specific position indicated by the specific position information 618. After the predetermined time period has passed, the CPU 121 restores the display state to the original state by displaying the displayed target image in the first area 211. The CPU 121 terminates the display processing.

As described above, the second terminal 12 sets the magnification factor so that the target block image fits inside the first area 211 of the display screen 21 displayed on the display 127 (step S92) and processes the target block image based on the set magnification factor (step S99 or step S101). When the processed target block image is displayed on the display 127, the entire processed target block image fits inside the first area 211 of the display screen 21. Therefore, since the participant using the second terminal 12 can recognize the entire target block image, the participant can easily recognize the content of the document image that is referred to by the presenter using the first terminal 11. The second terminal 12 can display the document image appropriately in a format that enables the content of the document image to be recognized easily.

When the area ratio is equal to or greater than “0.3” (no at step S97), a proportion of the enlarged target block image by the magnification factor to the first area 211 is large. Therefore, the second terminal 12 enlarges the entire target block image by the magnification factor calculated at step S92 and displays the entire target block image (step S101 and step S103). In this way, the participant can clearly recognize the entire target block image.

When the area ratio is less than “0.3” (yes at step S97), even when the entire block image is enlarged by the magnification factor, an improvement in viewability is limited. Therefore, the second terminal 12 enlarges, by the predetermined magnification factor, an image that is the specific position and adjacent to the specific position indicated by the specific position information 618 and displays the image (step S99 and step S103). In other word, the second terminal 12 magnifies, by a predetermined magnification factor, an area of the block image including the specific position but smaller than an entire area of the block image in response to a determination that the area ratio (the ratio of an magnified area to an area of a display area) is less than a threshold value. In this way, the participant can clearly recognize, of the target block image, the image located at the position on which the presenter has performed the predetermined operation.

When the second terminal 12 operates in the second mode, in some cases, different document images may be displayed on the first terminal 11 and the second terminal 12. In this case, the second terminal 12 displays the document image that includes the processed target block image (the first format) or the processed block image (the second format) while causing the document image or the processed block image to overlap with a part of the displayed target image (step S103). In this way, the participant can recognize both the target block image and part of the displayed target image. For example, by displaying both the target block image and the part of the displayed target image, the participant can verify that the second terminal 12 is operating in the second mode.

The first terminal 11 creates the block table 31 by analyzing the document image (step S213) and transmits the block table 31 to the second terminal 12. The second terminal 12 stores the block table 31 received from the first terminal 11 in the HDD 124. The second terminal 12 can process the target block image and display the target block image on the display 127 by referring to the stored block table 31. Since the second terminal 12 does not need to create the block table 31, it is possible to inhibit a processing load from increasing.

The present disclosure is not limited to the above-described embodiment, and various modifications can be made thereto. The analysis processing (refer to FIG. 4) and the detection processing (refer to FIG. 7) may be performed by the CPU 131 of the server 13. More specifically, the first terminal 11 may transmit only the document image file to the server 13 at step S215. The CPU 131 of the server 13 may perform the analysis processing based on the document image file received from the first terminal 11 and may create the block table 31 and store the block table 31 in the HDD 134. The CPU 131 may transmit the document image file received from the first terminal 11 and the created block table 31 to the second terminal 12 at step S217.

In place of the specific position information 618, the first terminal 11 may transmit the coordinate information (X, Y), which indicates the relative positions of the mouse, to the server 13 at step S235. The CPU 131 of the server 13 may determine whether the predetermined operation has been performed in the first terminal 11 by performing the detection processing based on the received coordinate information. When the CPU 131 determines that the predetermined operation has been performed, the CPU 131 may store the specific position information 618 in the packet 61 and transmit the packet 61 to the second terminal 12.

The remote conference system 1 need not necessarily include the server 13. In this case, the first terminal 11 and the second terminal 12 directly communicate with each other without going through the server 13.

When the predetermined operation is performed via the mouse of the input portion 17, the CPU 111 of the first terminal 11 may identify the block image on which the predetermined operation has been performed. The CPU 111 may include the block position information of the identified block image in the packet 61 as the specific position information 618 and may transmit the packet 61 to the second terminal 12 via the server 13. The CPU 121 of the second terminal 12 may identify the target block image based on the specific position information 618 included in the received packet 61.

The CPU 121 of the second terminal 12 may calculate the magnification factor at step S92 of the display processing (refer to FIG. 12) in the following manner. The CPU 121 may calculate, as the magnification factor, the magnification ratio that is required to extend the Y-axis direction length of the enlargement criterion block, which is identified at step S91, up to the vertical direction (Y-axis direction) length of the first area 211 of the display screen 21. The CPU 121 may calculate, as the magnification factor, the magnification ratio that is required to extend the X-axis direction length or the Y-axis direction length of the enlargement criterion block, which is identified at step S87, up to the horizontal direction (X-axis direction) or the vertical direction (Y-axis direction) length of the first area 211 of the display screen 21.

The CPU 121 of the second terminal 12 may decide the processing method of the target block image based on the calculated magnification factor at step S97 of the display processing. More specifically, when the calculated magnification factor is less than the predetermined threshold value, the CPU 121 may process the target block image into the first format. On the other hand, when the calculated magnification factor is equal to or greater than the predetermined threshold value, the CPU 121 may process the target block image into the second format.

When the target block image is processed into the first format, the CPU 121 of the second terminal 12 may cut out only an area that is the specific position and adjacent to a section of the target block image corresponding to the specific position indicated by the specific position information 618 included in the received packet 61. The CPU 121 may enlarge the cut-out section by the predetermined magnification factor and display the cut-out section in the first area 211 of the display screen 21.

When the page number 617 of the received packet 61 is different to the page number of the displayed target image, the CPU 121 of the second terminal 12 may display both the processed target block image and the displayed target image in the first area 211 of the display screen 21. In this case, the displayed target image is displayed at a reduced size. When the page number 617 of the received packet 61 is different to the page number of the displayed target image, the CPU 121 may display the document image that includes the processed target block image, or the processed target block image in the first area 211 of the display screen 21, in place of the displayed target image.

When the document image includes a plurality of textboxes, the CPU 111 of the first terminal 11 may identify each of the plurality of the textboxes as block images. When a separate image is associated with the document image, the CPU 111 may identify the separate image as a block image. At step S23 of the analysis processing, the CPU 111 of the first terminal 11 may group block images having a similar length in the Y-axis direction, among the plurality of the block images, into the same group.

The CPU 121 of the second terminal 12 may process another block image that belongs to the same group as the target block image, in the same manner as applied to the target block image and may display the block image in the display 127. As shown in FIG. 13, an example will be described in which the presenter has performed the predetermined operation on a part of the block image 29D via the first terminal 11. The CPU 121 of the second terminal 12 identifies the block image 29D as the target block image (step S87). The CPU 121 identifies the block image 29C, which belongs to the same group (the group number “2”) as the target block image (the block image 29D) and has the longest length in the X-axis direction, as the enlargement criterion block (step S89 and step S91).

The CPU 121 identifies the magnification factor based on the X-axis direction length of the enlargement criterion block (the block image 29C) (step S92). The CPU 121 calculates the block area by enlarging the target block image (the block image 29D) (step S93). The CPU 121 calculates the area ratio based on the block area and compares the area ratio with “0.3” (step S97). Based on the calculated magnification factor, the CPU 121 processes the target block image (the block image 29D) and the block image 29C, which belongs to the same group as the target block image, into the first format or the second format (step S99 and step S101). The CPU 121 displays the processed block images 29C and 29D on the display 127 in a format corresponding to the operation mode (step S103).

For example, when the block images 29C and 29D are processed into the first format, the block images 29C and 29D are displayed in the first area 211 of the display screen 21 while being arranged side by side in the horizontal direction. The magnifying glass 56 (refer to FIG. 14) is overlapped with a section of the block image 29D on which the predetermined operation has been performed. The part of the block image 29D arranged inside the magnifying glass 56 is enlarged by the predetermined magnification factor. By this, the participant can easily recognize the block image 29C, which belongs to the same group as the target block image as well as the target block image (the block image 29D). At the same time, since the section of the block image 29D on which the predetermined operation has been performed is enlarged, the participant can clearly recognize the section.

On the other hand, when the block images 29C and 29D are processed into the second format, the enlarged block images 29C and 29D are displayed in the first area 211 of the display screen 21 while being overlapped with each other. The target block image (the block image 29D) is arranged to the front of the block image 29C. Since the magnification factor is calculated based on the X-axis direction length of the enlargement criterion block (the block image 29C), both of the enlarged block images 29C and 29D fit in the first area 211. As a result, the participant can clearly recognize the entire block images 29C and 29D. At the same time, the participant can even more clearly recognize the entire block image 29D on which the predetermined operation has been performed.

As described above, when a plurality of the block images belong to the same group as the target block image, the second terminal 12 calculates the magnification factor based on the enlargement criterion block having the longest length in the X-axis direction among the plurality of the block images. When the second terminal 12 enlarges each of the plurality of the block images belonging to the same group as the target block image, the second terminal 12 can fit all of the plurality of the enlarged block images in the first area 211. By calculating the magnification factor by group in this manner, the second terminal 12 can appropriately set the magnification factor.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A non-transitory computer-readable medium storing computer-readable instructions, the instructions, when executed by a processor of a communication device, performing processes comprising:
a first receiving operation receiving, from an another communication device via a network, specific position information indicating a specific position in a display area on a display of the communication device;
a first determination operation determining whether block position information corresponding to the specific position indicated by the received specific position information is included in first block information stored in a storage device, the block position information indicating a position at which one of a plurality of block images is arranged, the plurality of block images being included in a display image of one page displayed on the display, the first block information being information in which a plurality of pieces of page information are associated with a plurality of pieces of block position information, each of the plurality of pieces of page information respectively identifying each of a plurality of display images corresponding to a plurality of pages, and each of the plurality of pieces of block position information indicating positions of the plurality of block images included in each of the display images for the plurality of the pages;
a setting operation setting a magnification factor of a target block image in response to determining that the block position information corresponding to the specific position is included in the first block information, the target block image being a block image among the plurality of block images, the target block image being arranged at a position indicated by the block position information corresponding to the specific position, the magnification factor being one of a first factor and a second factor, the first factor corresponding to a ratio of a length of the display area in the first direction to a length of the target block image in a first direction, the second factor corresponding to a ratio of a length of the display area in the second direction to a length of the target block image in a second direction, and the second direction being a direction perpendicular to the first direction;
a processing operation processing the target block image based on the set magnification factor; and
a display operation displaying the processed target block image on the display.

2. The non-transitory computer-readable medium according to claim 1, wherein the instructions, when executed by the processor of the communication device, further perform processes comprising:
a second determination operation determining whether a ratio of an magnified area to an area of the display area is equal to or greater than a first threshold value, wherein
the processing operation further comprises magnifying an entire area of the target block image by the magnification factor in response to the determination that the ratio of an magnified area to an area of the display area is equal to or greater than the first threshold value, the magnified area being an area of the target block image obtained when the target block image is magnified by the set magnification factor.

3. The non-transitory computer-readable medium according to claim 2, wherein
the processing operation further comprises magnifying, by a predetermined magnification factor, an area of the target block image including the specific position but smaller than the entire area of the target block image in response to the determination that the ratio of an magnified area to an area of the display area is less than the first threshold value.

4. The non-transitory computer-readable medium according to claim 1, wherein the instructions, when executed by the processor of the communication device, further perform processes comprising:
a second receiving operation receiving a piece of page information from an another communication device via the network; and wherein
the display operation further comprises:
displaying the processed target block image on the display in place of a displayed target image when the received piece of page information matches one of the plurality of pieces of page information, the one of the plurality of pieces of page information being included in the first block information and identifying the displayed target image, the displayed target image being the display image of one page that is being displayed on the display; and
displaying the processed target block image and at least a part of the displayed target image when the received piece of page information is different to one of the plurality of pieces of page information identifying the displayed target image.

5. The non-transitory computer-readable medium according to claim 1, wherein the instructions, when executed by the processor of the communication device, further perform processes comprising:
an identification operation identifying a plurality of block images corresponding to each of display images for a plurality of pages;
a transmission operation transmitting to an another communication device second block information via the network, the second block information being information in which a plurality of pieces of block position information are associated with a plurality of pieces of page information of the display images including the plurality of the identified block images;
a third receiving operation receiving the second block information from an another communication device via the network; and
a storage operation storing the received second block information in the storage device as the first block information.

6. The non-transitory computer-readable medium according to claim 5, wherein
the identification operation further comprises identifying the plurality of block images by extracting sections, in each of the display images for the plurality of pages, in which image density in each of the first direction and the second direction is greater than a second threshold value.

7. The non-transitory computer-readable medium according to claim 5, wherein the instructions, when executed by the processor of the communication device, further perform processes comprising:
a grouping operation grouping the plurality of identified block images into at least one group based on the plurality of pieces of block position information indicating indicate respective positions of the plurality of identified block images; and wherein
the transmission operation further comprises transmitting table information to an another communication device via the network, the table information being information in which the plurality of pieces of page information, the plurality of pieces of block position information, and group information are associated with each other, the group information being information identifying the at least one group.

8. The non-transitory computer-readable medium according to claim 7, wherein
the grouping operation further comprises grouping one or more of the block images having similar lengths in one of the first direction and the second direction into a same group, from among the plurality of block images.

9. The non-transitory computer-readable medium according to claim 7, wherein
the setting operation further comprises identifying at least one of the block images, which belongs to a same group as the target block image, based on the group information included in the first block information and setting the magnification factor based on one of a first length and a second length, the first length being a length in the first direction of a block image having the longest length in the first direction among the at least one identified block image, the second length being a length in the second direction of a block image having the longest length in the second direction among the at least one identified block image; and
the processing operation further comprises processing at least one of the target block image and the at least one block images that belong to the same group as the target block image, based on the magnification factor.

10. A communication device comprising:
a processor; and
a memory storing computer-readable instructions, the instructions, when executed by the processor, performing processes comprising:
a first receiving operation receiving, from an another communication device via a network, specific position information indicating a specific position in a display area on a display of the communication device;
a first determination operation determining whether block position information corresponding to the specific position indicated by the received specific position information is included in first block information stored in a storage device, the block position information indicating a position at which one of a plurality of block images is arranged, the plurality of block images being included in a display image of one page displayed on the display, the first block information being information in which a plurality of pieces of page information are associated with a plurality of pieces of block position information, each of the plurality of pieces of page information respectively identifying a plurality of display images corresponding to a plurality of pages, and each of the plurality of pieces of block position information indicating positions of the plurality of block images included in each of the display images for the plurality of the pages;
a setting operation setting a magnification factor of a target block image in response to determining that the block position information corresponding to the specific position is included in the first block information, the target block image being a block image among the plurality of block images, the target block image being arranged at a position indicated by the block position information corresponding to the specific position, the magnification factor being one of a first factor and a second factor, the first factor corresponding to a ratio of a length of the display area in the first direction to a length of the target block image in a first direction, the second factor corresponding to a ratio of a length of the display area in the second direction to a length of the target block image in a second direction, and the second direction being a direction perpendicular to the first direction;
a processing operation processing the target block image based on the set magnification factor; and
a display operation displaying the processed target block image on the display.

11. The communication device according to claim 10, wherein the instructions, when executed by the processor, further perform processes comprising:
a second determination operation determining whether a ratio of an magnified area to an area of the display area is equal to or greater than a first threshold value, wherein
the processing operation further comprises magnifying an entire area of the target block image by the magnification factor in response to the determination that the ratio of an magnified area to an area of the display area is equal to or greater than the first threshold value, the magnified area being an area of the target block image obtained when the target block image is magnified by the set magnification factor.

12. The communication device according to claim 11, wherein
the processing operation further comprises magnifying, by a predetermined magnification factor, an area of the target block image including the specific position but smaller than the entire area of the target block image in response to the determination that the ratio of an magnified area to an area of the display area is less than the first threshold value.

13. The communication device according to claim 10, wherein the instructions, when executed by the processor, further perform processes comprising:
a second receiving operation receiving a piece of page information from an another communication device via the network; and wherein
the display operation further comprises:
displaying the processed target block image on the display in place of a displayed target image when the received piece of page information matches one of the plurality of pieces of page information, the one of the plurality of pieces of page information being included in the first block information and identifying the displayed target image, the displayed target image being the display image of one page that is being displayed on the display; and
displaying the processed target block image and at least a part of the displayed target image when the received piece of page information is different to one of the plurality of pieces of page information identifying the displayed target image.

14. The communication device according to claim 10, wherein the instructions, when executed by the processor, further perform processes comprising:
an identification operation identifying a plurality of block images corresponding to each of display images for a plurality of pages;
a transmission operation transmitting to an another communication device second block information via the network, the second block information being information in which a plurality of pieces of block position information are associated with a plurality of pieces of page information of the display images, the plurality of pieces of block position information respectively indicate positions of each of the plurality of the identified block images, the plurality of pieces of page information of the display images including the plurality of the identified block images;
a third receiving operation receiving the second block information from an another communication device via the network; and
a storage operation storing the received second block information in the storage device as the first block information.

15. The communication device according to claim 14, wherein
the identification operation further comprises identifying the plurality of block images by extracting sections, in each of the display images for the plurality of pages, in which image density in each of the first direction and the second direction is greater than a second threshold value.

16. The communication device according to claim 14, wherein the instructions, when executed by the processor, further perform processes comprising:
a grouping operation grouping the plurality of identified block images into at least one group based on the plurality of pieces of block position information indicating respective positions of the plurality of identified block images; and wherein
the transmission operation further comprises transmitting table information to an another communication device via the network, the table information being information in which the plurality of pieces of page information, the plurality of pieces of block position information, and group information are associated with each other, the group information being information identifying the at least one group.

17. The communication device according to claim 16, wherein
the grouping operation further comprises grouping one or more of the block images having similar lengths in one of the first direction and the second direction into a same group, from among the plurality of block images.

18. The communication device according to claim 16, wherein
the setting operation further comprises identifying at least one of the block images, which belongs to a same group as the target block image, based on the group information included in the first block information and setting the magnification factor based on one of a first length and a second length, the first length being a length in the first direction of a block image having the longest length in the first direction among the at least one identified block image, the second length being a length in the second direction of a block image having the longest length in the second direction among the at least one identified block image; and
the processing operation further comprises processing at least one of the target block image and the at least one block images that belong to the same group as the target block image, based on the magnification factor.

19. A communication method comprising:
a receiving operation receiving, from an another communication device via a network, specific position information indicating a specific position in a display area on a display of a communication device;
an identification operation identifying block position information corresponding to the specific position indicated by the received specific position information, the block position information indicating a position at which one of a plurality of block images is arranged, the plurality of block images being included in a display image of one page that is displayed on the display;
a magnification operation magnifying a target block image, the target block image being a block image among the plurality of block images arranged at a position indicated by the block position information corresponding to the specific position; and
a display operation displaying the magnified target block image on the display.
